(19) United States
(12) Patent Application Publication
(10) Pub. No.: US 2005/0177488 A1
(43) Pub. Date: Aug. 11, 2005

(54) Rent default insurance method

(76) Inventor: Marc Rexrode, San Diego, CA (US)

Correspondence Address: Jonathan E. Jobe, Jr.;Pillsbury Winthrop LLP, Suite 200, 11682 El Camino Real, San Diego, CA, 92130, US

(21) Appl. No.: 10/773,829

(22) Filed: Feb. 5, 2004

(51) Int. Cl. G06F 17/60

(52) U.S. Cl. 705/38

(57) ABSTRACT

A method of insuring a lessor against default on the part of a lessee may provide indemnification for the lessor if the lessee defaults on a rental agreement. An exemplary method of insuring a lessor may allocate risk of default to the lessee, requiring a lessee of questionable creditworthiness to assume the cost, or at least a portion thereof, associated with appropriate insurance coverage for the benefit of the lessor.

### FIELD OF THE INVENTION

Aspects of the present invention relate generally to rental agreements, and more particularly to a method of insuring a lessor against rent default on the part of a lessee having credit problems.

### DESCRIPTION OF THE RELATED ART

Typical rental agreements require that a potential lessee's creditworthiness be scrutinized. Even where a satisfactory credit rating is not specifically addressed within the rental contract itself, most lessors insist upon renting only to lessees having excellent credit ratings characterized by satisfactory payment histories; such insistence, in theory, protects the lessor against default on the part of a lessee with a history of payment anomalies (such as late or missed payments, for example). In many instances, potential renters who are otherwise qualified to enter into an agreement are rejected, or never even considered, by a lessor due to creditworthiness considerations.

Conventional real estate rental methodologies, for example, are deficient at least to the extent that poor credit often prevents otherwise qualifying renters from being considered for occupation of certain rental properties. In that regard, creditworthiness considerations may unnecessarily or inconveniently limit the universe of potential tenants from which a landlord may select. What is needed in this context is a method to insure a landlord against the risk that a tenant having credit problems will default on rent payments. More broadly, such insurance may have applications in other types of lessor/lessee relationships where the lessee may be of questionable creditworthiness as measured by conventional rating systems.

### SUMMARY

Embodiments of the present invention overcome the above-mentioned and various other shortcomings of conventional leasing or rental strategies, providing a method of insuring a lessor against rent default on the part of a lessee having questionable creditworthiness. In accordance with the present disclosure, embodiments of a method of insuring a lessor may allocate risk of default to the lessee, requiring the lessee to assume the cost, or at least a portion thereof, associated with appropriate insurance coverage for the benefit of the lessor.

In accordance with one exemplary embodiment, an insurance method comprises: determining that a lessee fails to qualify for credit in accordance with predetermined creditworthiness considerations; providing insurance coverage to a lessor entering into a rental agreement with the lessee; and responsive to the determining, requiring that the lessee bear a cost associated with the providing as a precondition for entering into the rental agreement. The method may further comprise indemnifying the lessor if the lessee defaults on the rental agreement for failure to make timely payments.

Insurance coverage as set forth herein may be terminated, for example, if the lessee does not default on the rental agreement for a predetermined or specified duration; alternatively, while the coverage may continue, the costs associated with providing the insurance may be shifted to the lessor if the lessee does not default for a predetermined duration.

Exemplary embodiments include indemnification strategies, such as reimbursing the lessor for fees or rent due in accordance with the rental agreement; additionally or alternatively, indemnification may comprise reimbursing the lessor for expenses, such as legal fees or reasonable incidental costs, associated with default of the rental agreement on the part of the lessee.

In accordance with one embodiment having particular utility in a residential real estate context, a method of insuring a landlord against rent default generally comprises: providing insurance coverage to the landlord entering into a rental agreement with a tenant who does not satisfy predetermined credit considerations; and allocating a cost of the providing to the tenant as a precondition for entering into the rental agreement.

As with the foregoing method, embodiments directed to landlord/tenant relationships may include indemnifying the landlord if the rental agreement is breached for failure to pay rent. Such indemnification may encompass, for example: reimbursing the landlord for unpaid rent due in accordance with the rental agreement; reimbursing the landlord for expenses associated with collecting the unpaid rent or evicting the tenant; or both. Costs associated with the insurance coverage, such as insurance premiums, may be reallocated to the landlord if the rental agreement is not breached by the tenant for a predetermined duration for failure to pay rent.

The foregoing and other aspects of various embodiments of the present invention will be apparent through examination of the following detailed description thereof in conjunction with the accompanying drawings.

### BRIEF DESCRIPTION OF THE DRAWINGS

FIGS. 1 and 2 are simplified flow diagrams illustrating the general operation of one embodiment of a rent default insurance method.

### DETAILED DESCRIPTION

As set forth in more detail below, insurance strategies operative in accordance with the present disclosure relate generally to allocating risk of default in a lessor/lessee relationship. In exchange for leniency with respect to creditworthiness considerations, an otherwise qualifying lessee with an unsatisfactory credit rating may be required to bear the cost of rent default insurance premiums, or a portion of such premiums. Insurance coverage as set forth herein may protect the lessor against payment default at minimal or no cost to the lessor by requiring that such cost be allocated, in whole or in part, to the lessee as a condition precedent of the rental agreement.

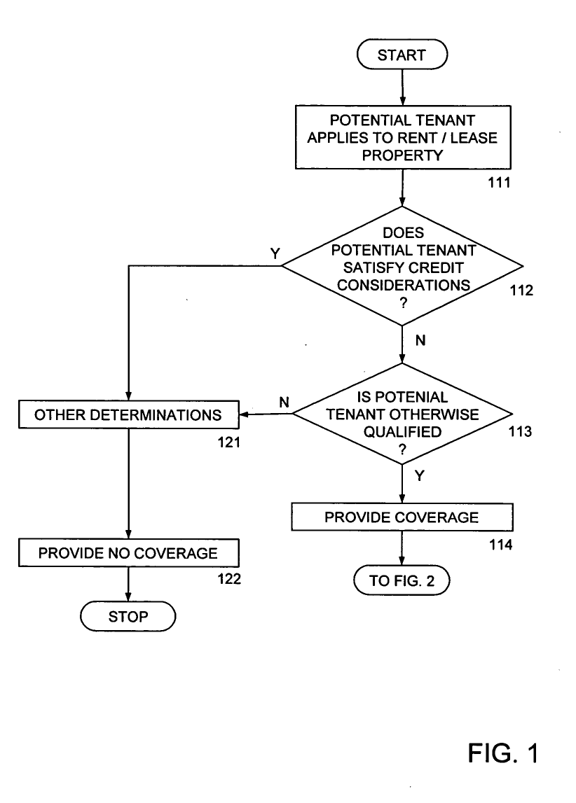

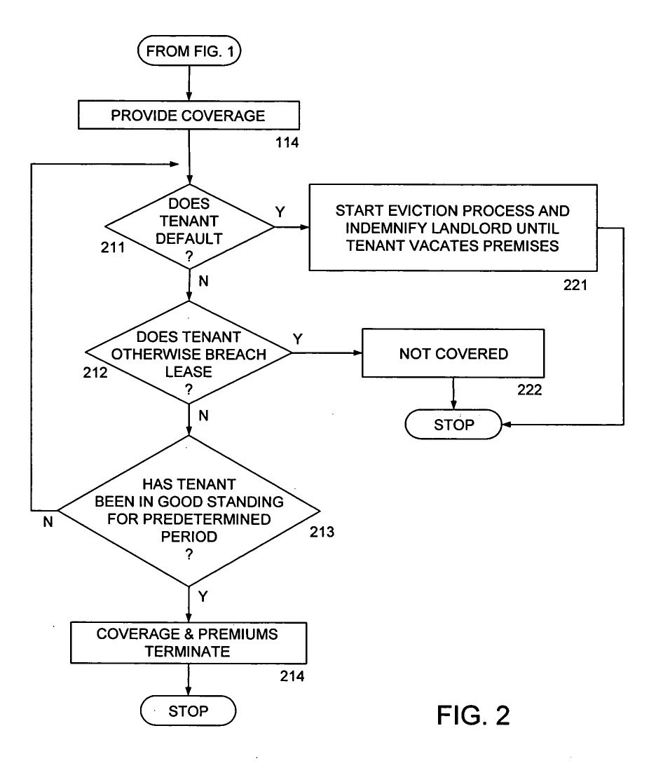

Turning now to the drawing figures, FIGS. 1 and 2 are simplified flow diagrams illustrating the general operation of one embodiment of a rent default insurance method. Those of skill in the art will appreciate that the exemplary embodiment depicted in the drawing figures is susceptible of numerous modifications. For example, the order, interrelationship, or general functionality underlying the various operations may be altered in accordance with requirements or provisions set forth in a particular rental agreement, relevant statutes or municipal codes, government assisted housing laws, or other practical considerations. Additionally, as will become apparent from examination of the following description, some or all of the functionality set forth herein may have utility in rental agreements beyond the residential real estate context.

As indicated at block 111, a method of insuring a landlord may begin with a potential tenant submitting a rental application. In some instances, such an application may be submitted with respect to a specific property (e.g., a house, an apartment, a condominium, a room in one of the foregoing that may be shared with another tenant, etc.) that is currently, or soon to be, available for occupancy. Additionally or alternatively, such an application may be submitted prospectively, such as when a potential tenant wishes to be considered for occupancy with respect to any unit in a particular complex (such as an apartment building or condominium complex, for example) or managed by a particular rental agency that eventually becomes available in the future.

As noted above, a creditworthiness determination for a potential tenant is generally made as indicated at decision block 112. Most landlords require that a lessee or tenant qualify for credit in accordance with standard industry investigatory practices or other predetermined creditworthiness considerations. In that regard, “qualifying for credit” (i.e., establishing “creditworthiness”) in this context generally refers to demonstrating a history of timely payments, as such payments may be reported to, or monitored by, a credit reporting agency or other entity. By way of example, Experian™, Equifax™, and Trans Union™ are industry recognized credit reporting agencies that monitor account status data and report such information as a service to banks, mortgage companies, lenders, and other entities interested in acquiring information regarding extended credit lines, outstanding balances, payment histories, and so forth. Each of these services is capable of providing, upon request and proper authorization, for example, a credit score or rating for individuals or business entities; the scores are generally based upon proprietary mathematical models as well as financial data and other information currently available to the agency.

Other creditworthiness considerations contemplated at decision block 112 may include rental history, as such may be recorded or documented by the potential tenant's references, for example, or by previous landlords. Additionally or alternatively, rental history or a pattern of delinquent payments may be documented by the credit reporting agencies (if such data are available to them) or other agencies dedicated to monitoring activity in a particular industry such as residential real estate rentals. In that regard, it will be appreciated that a prospective tenant's ability to qualify for credit in accordance with the creditworthiness evaluation represented at decision block 112 may be context specific, i.e., the determination may include numerous and varied considerations depending upon, among other factors, the nature, length, and specific payment obligations set forth in the proposed rental agreement.

As indicated by the arrow to the left of decision block 112, if a potential lessee qualifies for credit, for example, by satisfying a predetermined or established set of creditworthiness criteria or considerations, rent default insurance will ultimately not be provided (block 122) in accordance with the present disclosure. In the exemplary embodiment, provision of insurance (a cost associated with which is borne by the lessee) is generally contingent upon failure of the lessee or renter to qualify for credit in accordance with one or more considerations or standards, i.e., the lessee fails to establish a record or history of creditworthiness. The present disclosure is not intended to be so limited, however, and other embodiments are contemplated for allocating the burden of insurance to the lessee. For example, the lessee may be required to bear the cost associated with rent default insurance premium payments as set forth herein merely as a matter of the lessor's convenience, or for other reasons specified or otherwise mandated by the lessor.

If a potential lessee fails to qualify for credit in accordance with predetermined or established creditworthiness criteria or considerations as set forth above, a determination may be made regarding the lessee's qualifications in other respects as generally indicated at decision block 113 and block 121. Such other determinations, depicted at block 121, may include factors such as, inter alia: whether the potential tenant currently owns a pet; whether the potential tenant has a record of felony convictions; whether the potential tenant satisfies age requirements in a senior citizens' community; and so forth. It will be appreciated that the operations depicted at blocks 113 and 121 may be context specific and influenced by, for example, the preferences of the lessor (or the lessor's agent or representative); additionally, as is generally known in the art, the nature and extent of these determinations may be proscribed or otherwise governed by federal, state, or local laws, or some combination thereof. The present disclosure is not intended to be limited by the scope and character of the determinations contemplated at block 121 and the evaluation process illustrated at decision block 113.

As set forth above and generally indicated in FIG. 1, the exemplary method contemplates provision of rent default insurance in the case where a potential lessee fails to qualify for credit, but otherwise proves to be a qualified rental applicant. In that regard, if a determination is made (in accordance with blocks 113 and 121) that the lessee is not otherwise qualified to rent the property in question for some other reason (i.e., irrespective of, or independent of, creditworthiness considerations), then no rent default insurance will be provided as indicated at block 122. The lessor is unlikely to enter into a rental agreement with such a potential lessee in any event. Conversely, a determination at block 113 that the potential lessee is generally otherwise qualified (independent of the foregoing and other creditworthiness considerations) for consideration as a renter of the property in question, rent default insurance coverage may be provided as indicated at block 114.

In accordance with some embodiments, the lessee may be required to bear the cost, in whole or in part, associated with the insurance provided at block 114; in some exemplary circumstances, requiring that the lessee assume the risk (and the expenses attendant therewith) of such default may be a precondition for entering into the rental agreement. Accordingly, the risk of default may be allocated to a lessee having less than satisfactory credit scores or ratings; such an insurance strategy may guarantee the landlord rent which is due in accordance with the rental agreement at little or no cost.

The insurance provided at block 114 may generally require payment of premiums in exchange for coverage agreed upon as specified by an insurance policy. As generally known in the art, such premiums may be due and payable on a monthly basis, or on some other payment schedule (such as annually or semi-annually, for example) as determined or required by the insurance provider. Payments may be made by the lessee directly to the insurance provider for the benefit of the lessor; alternatively, the lessee may reimburse the lessor for such costs in addition to payment of rent ordinarily due under the rental agreement.

The insurance policy contemplated by the operation depicted at block 114 may provide for indemnifying the lessor if the lessee defaults on the rental agreement by failing to make regularly scheduled rent payments. As set forth in more detail below, in some embodiments, rent default insurance coverage may be terminated if the lessee does not default on the rental agreement for a predetermined duration; alternatively, if the lessor desires to continue coverage, the cost of the insurance premiums may be shifted to the lessor if the lessee does not default for a predetermined duration.

In this context, “indemnifying” generally refers to reimbursing the lessor for unpaid fees due, such as rent, in accordance with the rental agreement. Additionally or alternatively, indemnifying may encompass or include reimbursing the lessor for expenses associated with default of the rental agreement; examples of such expenses include, but are not limited to, legal fees or incidental expenses associated with evicting the delinquent tenant.

Contingencies, such as rights and responsibilities of each party (i.e., the lessor, the lessee, and the insurance provider) in the case where the tenant fails to pay the insurance premiums as contemplated at block 114, may be the subject of agreement between all the parties, for example, or between various combinations thereof. In some embodiments, for instance, failure on the part of the lessee to make timely payments on the insurance policy may be treated as a breach of the rental agreement, and may accordingly be grounds for eviction; in some such instances tended to promptly by the lessor, for example, the costs associated with the eviction may be covered under the insurance policy. Numerous variations exist; the present disclosure is not intended to be limited by the scope and contemplation of any agreements between and amongst the various parties regarding potential contingencies that may arise.

Turning now specifically to FIG. 2, it will be appreciated that the providing operations depicted at the blocks labeled 114 in both of FIGS. 1 and 2 are identical. As noted above, the rent default insurance methodologies set forth herein are intended generally to protect the lessor from default on the part of a lessee who has failed to satisfy certain creditworthiness standards. In that regard, a determination may be made (as indicated at decision block 211) whether the tenant has defaulted specifically for failure to pay rent in accordance with the rental agreement. If the tenant or lessee is found to be sufficiently delinquent on payments in accordance with the rental agreement, that failure to pay rent may be considered a material breach of the rental agreement, the insurance policy, or both; accordingly, the eviction process may begin. As indicated at block 221, the landlord may be indemnified for the eviction proceedings. This indemnification may include reimbursement for lost rent, legal fees, and other incidental costs associated with the eviction, for example, as noted above. In accordance with industry standards and the respective motivations of the parties to be bound, specific indemnification provisions may depend upon, or be influenced by, inter alia, the terms of the insurance policy, the status of payments due under that insurance policy, and other factors.

As generally indicated in FIG. 2, if a tenant does not breach the rental agreement specifically for failure to pay rent due, rent default insurance may not apply in accordance with the exemplary embodiment. For example, if a determination is made at decision block 212 that the tenant is in breach of the rental agreement for some reason unrelated to delinquent rent, the insurance coverage provided at block 114 may not be used to indemnify nor otherwise to compensate the landlord. Examples of such unrelated breaches include, but are not limited to, destruction of the subject property, conducting illegal activities on the property, maintaining pets in violation of the rental agreement, and so forth. Specifically, breaches of the rental agreement which are independent of failure to pay rent may not be covered by the rent default insurance methodologies set forth herein, as indicated at block 222.

If the tenant is in good standing for a predetermined period or duration, however, the tenant may be considered or presumed to be creditworthy and reliable as a result of consistent and timely satisfaction of payment obligations. Accordingly, if the tenant does not default for failure to pay rent (block 211) and is not otherwise in breach of the rental agreement (block 212) for a specified or predetermined period of time, a determination may be made that the tenant's good standing merits the landlord's trust; the landlord may therefore be expected to assume the risk that the tenant will default in the future. In that regard, a determination may be made at decision block 213. If the tenant has not performed under the rental agreement for a predetermined or requisite period of time, ongoing scrutiny may be maintained as indicated by the loop back to decision block 211.

Conversely, if the tenant has neither breached for failure to pay rent nor for any other reason for a specified duration as required at block 213, then rent default insurance coverage, in general, and the lessee's obligation to make premium payments associated therewith, in particular, may be terminated. In alternative embodiments, the lessor may assume the responsibility of maintaining insurance coverage by bearing the burden of making the premium payments; the operation at block 214 is intended only to indicate that the lessee no longer carries the burden of providing insurance coverage for the benefit of the lessor.

Various alternatives exist with respect to the exemplary embodiment, and the presented order of the individual blocks is not intended to imply a specific sequence of operations to the exclusion of other possibilities. Specifically, the particular application, any agreements between the parties, and overall industry requirements may dictate the most efficient or desirable sequence of the operations set forth in FIG. 2. Individual operations depicted as discrete blocks (such as, for example, the determinations at decision blocks 211 and 212) may be integrated or combined, for example, where appropriate.

Though not limited with respect to particular contexts and implementations, the foregoing embodiments or modified versions thereof may have specific utility in conjunction with residential real estate rental agreements. Additionally or alternatively, the foregoing functionality may be employed in conjunction with methods of insuring and indemnifying lessors in other contexts such as, for example, automobile or other vehicle leasing agreements; other practical applications of lessor insurance methodologies as set forth herein are contemplated.

Several features and aspects of the present invention have been illustrated and described in detail with reference to particular embodiments by way of example only, and not by way of limitation. Those of skill in the art will appreciate that alternative implementations and various modifications to the disclosed embodiments are within the scope and contemplation of the present disclosure. Therefore, it is intended that the invention be considered as limited only by the scope of the appended claims.

1. A method comprising:
determining that a lessee fails to qualify for credit in accordance with predetermined creditworthiness considerations;
providing insurance coverage to a lessor entering into a rental agreement with said lessee; and
responsive to said determining, requiring that said lessee bear a cost associated with said providing as a precondition for entering into said rental agreement.

2. The method of claim 1 further comprising indemnifying said lessor if said lessee defaults on said rental agreement.

3. The method of claim 1 further comprising confirming that said lessee satisfies criteria other than said creditworthiness considerations required for entering into said rental agreement.

4. The method of claim 1 further comprising terminating said insurance coverage if said lessee does not default on said rental agreement for a predetermined duration.

5. The method of claim 1 further comprising shifting to said lessor said cost associated with said providing if said lessee does not default on said rental agreement for a predetermined duration.

6. The method of claim 2 wherein said indemnifying comprises reimbursing said lessor for fees due in accordance with said rental agreement.

7. The method of claim 2 wherein said indemnifying comprises reimbursing said lessor for expenses associated with default of said rental agreement.

8. A method of insuring a landlord against rent default comprising:
determining whether a tenant satisfies predetermined creditworthiness considerations;
responsive to a negative result of said determining, providing insurance coverage to said landlord entering into a rental agreement with said tenant; and
requiring that said tenant bear a cost associated with said providing as a precondition for entering into said rental agreement.

9. The method of claim 8 further comprising indemnifying said landlord if said rental agreement is breached for failure to pay rent.

10. The method of claim 8 further comprising confirming that said tenant satisfies criteria other than said creditworthiness considerations required for entering into said rental agreement.

11. The method of claim 8 further comprising terminating said insurance coverage if said rental agreement is not breached for a predetermined duration for failure to pay rent.

12. The method of claim 8 further comprising shifting to said landlord said cost associated with said providing if said rental agreement is not breached for a predetermined duration for failure to pay rent.

13. The method of claim 9 wherein said indemnifying comprises reimbursing said landlord for unpaid rent due in accordance with said rental agreement.

14. The method of claim 13 wherein said indemnifying further comprises reimbursing said landlord for expenses associated with collecting said unpaid rent.

15. A method of insuring a landlord against rent default comprising:
providing insurance coverage to said landlord entering into a rental agreement with a tenant who does not satisfy predetermined credit considerations; and
allocating a cost of said providing to said tenant as a precondition for entering into said rental agreement.

16. The method of claim 15 further comprising indemnifying said landlord if said rental agreement is breached for failure to pay rent.

17. The method of claim 15 further comprising reallocating to said landlord said cost of said providing if said rental agreement is not breached for a predetermined duration for failure to pay rent.

18. The method of claim 16 wherein said indemnifying comprises reimbursing said landlord for unpaid rent due in accordance with said rental agreement.

19. The method of claim 18 wherein said indemnifying further comprises reimbursing said landlord for expenses associated with collecting said unpaid rent.
